(19) United States
(12) Patent Application Publication
(10) Pub. No.: US 2015/0027031 A1
(43) Pub. Date: Jan. 29, 2015

(54) Tommaso's De-Hooker

(71) Applicant: Gaspare Joseph Tommaso, Brooklyn, NY (US)

(72) Inventor: Gaspare Joseph Tommaso, Brooklyn, NY (US)

(21) Appl. No.: 13/952,612

(22) Filed: Jul. 27, 2013

(51) Int. Cl. A01K 97/18

(52) U.S. Cl. CPC A01K 97/18
USPC 43/53.5

(57) ABSTRACT

Tommaso's De-Hooker is a device designed to remove a fishhook swallowed by a fish as humanely as possible so as not to unduly injure the fish. The function of the De-Hooker is to dislodge the hook from the fish using only one hand. This frees the other hand to hold the fish, or for whatever purpose the fisherman wants to use it.

### CROSS-REFERENCE TO RELATED APPLICATIONS

### Description of Prior Art

The following patents were found during the course of a search of the United States Patent Office:

U.S. PATENT DOCUMENTS

| Patentee | US Pat. No. | Date of Issue |
|---|---|---|
| Swindle | 4,914,853 | Apr. 10, 1990 |
| Tice | 4,006,554 | Feb. 8, 1977 |
| Swidle | 4,914,853 | Apr. 10, 1990 |
| Neal | 4,473,966 | Oct. 2, 1984 |

An objective of the invention is to overcome some of the drawbacks relating to the designs of previous fishhook removal devices. The main problem that I found is that none of the patented devices cross-referenced above as related applications could hold the hook securely, and the hook could not be withdrawn from the fish without re-snagging the hook inside the fish. This is also a problem of snagging the hook back into the fish is also present when using pliers. My De-Hooker solves this problems by strongly securing the hook to itself, so that the point of the hook cannot come in contact with the flesh of the fish as the hook is withdrawn from the fish. I have invented Tommaso's De-Hooker to provide the sport fisherman a more humane way to remove the fishing hook from a fish during catch and release.

### BACKGROUND OF THE INVENTION

### Field of the Invention

This invention relates generally to devices having utility in the fishing industry, and more specifically to devices used to extract a fishing hook from a hooked fish, while doing as little harm to the fish that swallowed it as possible.

### SUMMARY OF THE INVENTION

In accordance with the purposes of the present invention, as embodied and broadly described herein, the present invention was designed with ease of use in mind. Once the leader is attached to one of the hooks in the T part, It allows the user to hold the fish with one hand, and use the De-Hooker with the other hand. First the leader loop is hooked on. Then the chisel end of the rod is inserted into the fish's mouth along the leader towards the hook. The rod part of Tommaso's De-Hooker is pushed along by the pressure of the thumb on the rod and the opposite pressure of the fingers on the T part as illustrated in FIG. 5. This will secure the hook against the chisel tip of Tommaso's De-Hooker. Once the hook is secured, a gentle push into the fish will release the hook from the fish and lodge it ino the chisel part of the De-Hooker. The dislodging of the hook can actually be felt. Tommaso's De-Hooker can now be extracted from the fish.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings, I will endeavor to show all of the parts of the invention, and how the invention is made to function. The drawings are not necessarily drawn to scale:

FIG. 1 shows what may be a rivet, or nail, or screw, or bolt which is used to secure the T part shown in FIG. 3 to the rod in FIG. 2

FIG. 2 shows a diagram of a four sided rod with one end shaped like a chisel, and showing the location of a hole in the rod.

FIG. 3 Shows the T shaped part of Tommaso's De-Hooker, including the channel in the lower part, and the hook projections

FIG. 4 shows the assembled Tommaso's De-Hooker.

FIG. 5 shows the assembled Tommaso's De-Hooker. It also shows the loop in the leader on one of the hooks of the T part of the De-Hooker.

FIG. 6 shows the positioning of the hook so as to have the point of the hook be pressed against the chisel part of the De-Hooker, and the position of the fingers of the right or left hand used to operate the De-Hooker.

### DETAILED DESCRIPTION OF THE PREFERRED EMBODIMENT

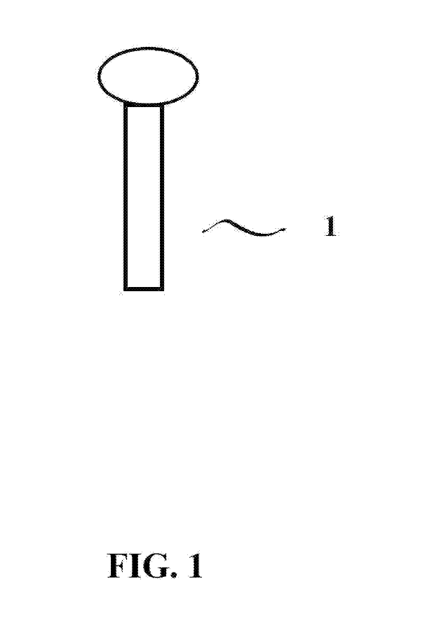

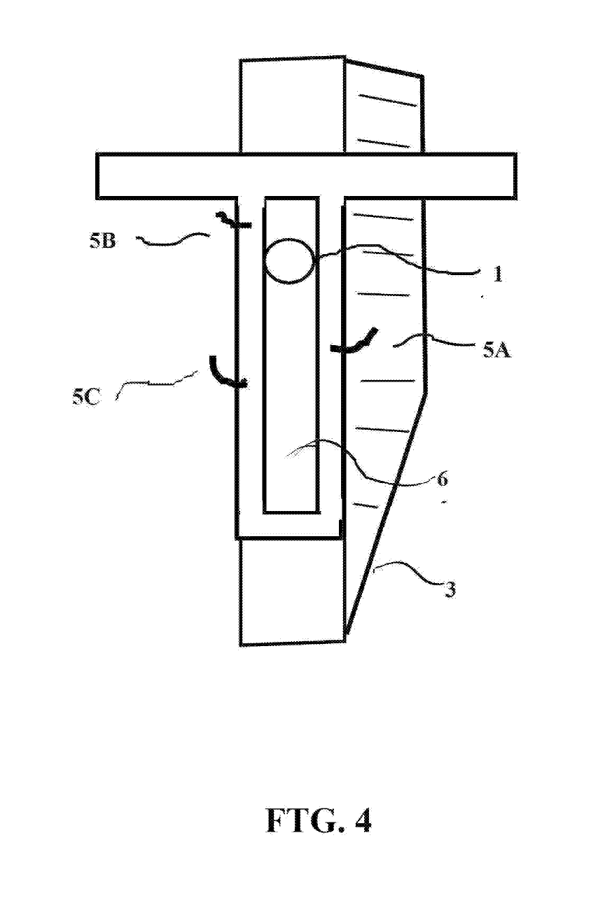

Referring to FIG. 4 there will be seen that the preferred embodiment of the invention includes a four sided rod with one end shaped like a chisel, and showing the location of a hole in the rod as shown in FIG. 1, and described in claim 2. This rod is preferably made of wood, but plastic or metal can be used. I prefer the use of wood because of its innate ability to help kill bacteria. This was shown in a 1993 study where Microbiologists at the University of Wisconsin's Food Research tested the antibacterial ability of wood. Researchers at the Institute contaminated both wooden cutting boards and plastic ones with all types of bacteria that cause food poisoning. They then tested the boards regularly, without washing or touching them, to see what happened to the bacteria. Surprisingly, all the bacteria on the wooden board dried off within three minutes. On the plastic board, the bacteria not only remained alive but actually multiplied overnight.

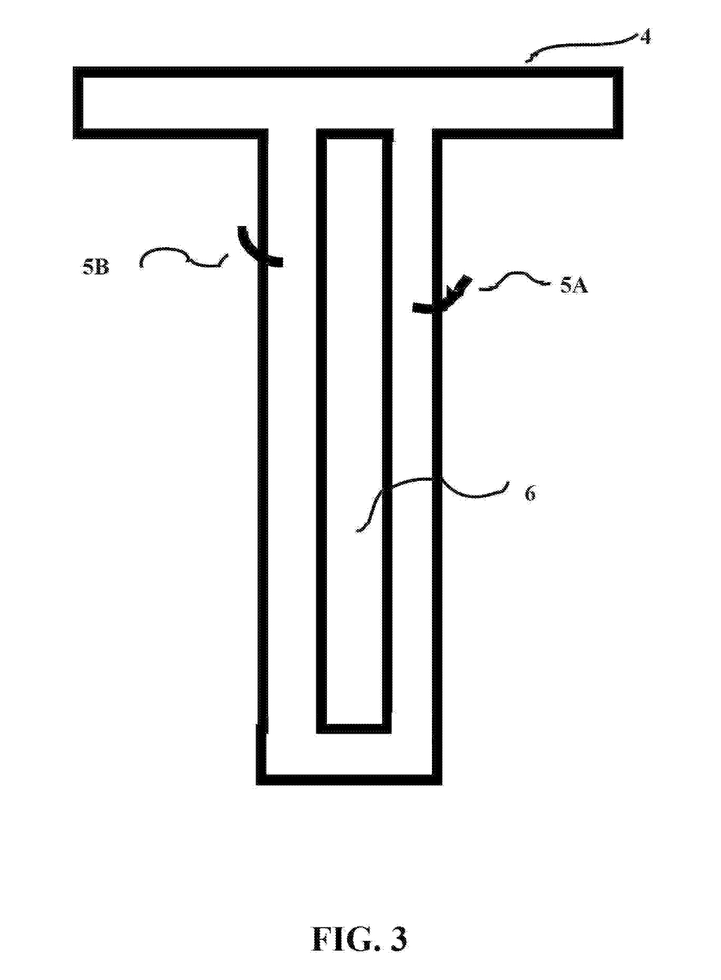

The embodiment of the invention also includes a T shaped part as shown In FIG. 3 and described in claims 2, 3, 4, 5, and 6. The T part is preferably made of wood, except for the hooks FIG. 3, 5A-5B which are preferably made of stainless steel.

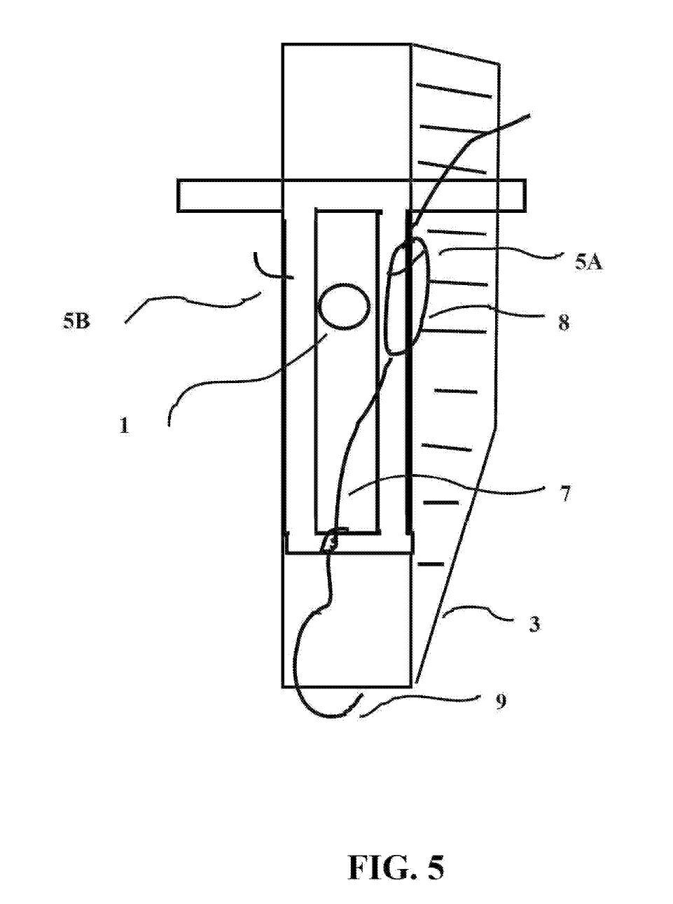

Once the leader is attached to one of the hooks in the T part, It allows the user to hold the fish with one hand, and use the De-Hooker with the other hand. First the leader loop is hooked on. Then the chisel end of the rod is inserted into the fish's mouth along the leader towards the hook. The rod part of Tommaso's De-Hooker is pushed along by the pressure of the thumb on the rod and the opposite pressure of the fingers on the T part as illustrated in FIG. 5. This will secure the hook against the chsel tip of Tommaso's De-Hooker. Once the hook is secured, a gentle push into the fish will release the hook from the fish and lodge it ino the chisel part of the De-Hooker. The dislodging of the hook cannot actually be felt. Tommaso's De-Hooker can now be extracted from the fish.

I claim:

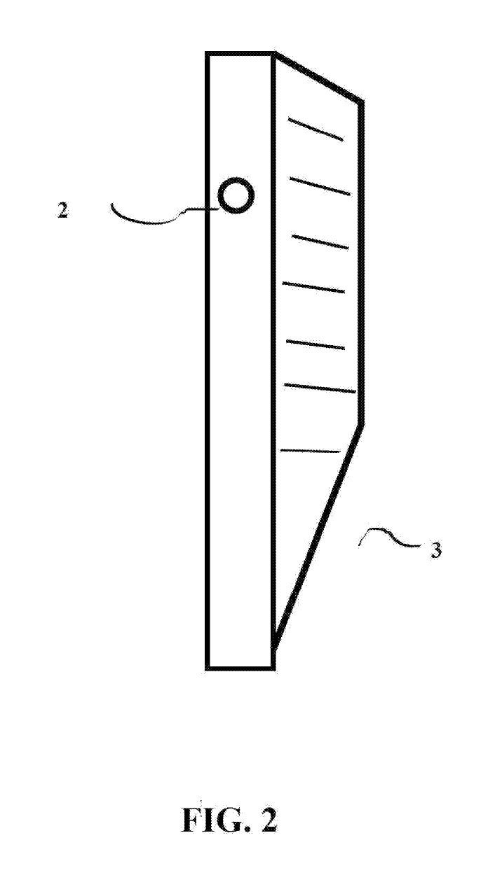

1. A rod with four rectangular sides, or any rod ending in the form of a chisel as shown in drawing (FIG. 2).

2. A T shaped part that is attached to the rod described in claim 1. This part is in the form of a T. The T consists of a two sections at right angles to each other. The lower portion of the T immediately below the top part (FIG. 3, 4) and extending to the end is flat and has a channel (FIG. 3, 6). The channel is along the center part of the T extending from immediately were the right angles are formed to close at the end of the bottom part of the T. (FIG. 3).

3. The channel described in claim 2 can be made from one sixteenth of an inch wide to a quarter inch wide.

4. The T shaped part that (FIG. 3) is secured to the rod (FIG. 2) described in claim 1 by:
a. Placing the T shaped part (FIG. 3) on top of the rod (FIG. 2) so that it lays on the section of the rod shown in (FIG. 4).
b. The hole (FIG. 2, 2) can be seen through the channel of the T shaped part (FIG. 3). And one rivet, or nail, or screw, or bolt (FIG. 1, 1) all of which have a flat head that Is wider than the width of the channel in the T shaped part (FIG. 3, 6) can be inserted into this hole (FIG. 2, 2) leaving enough slack to allow the rod to be moved along the channel of the T shaped part.

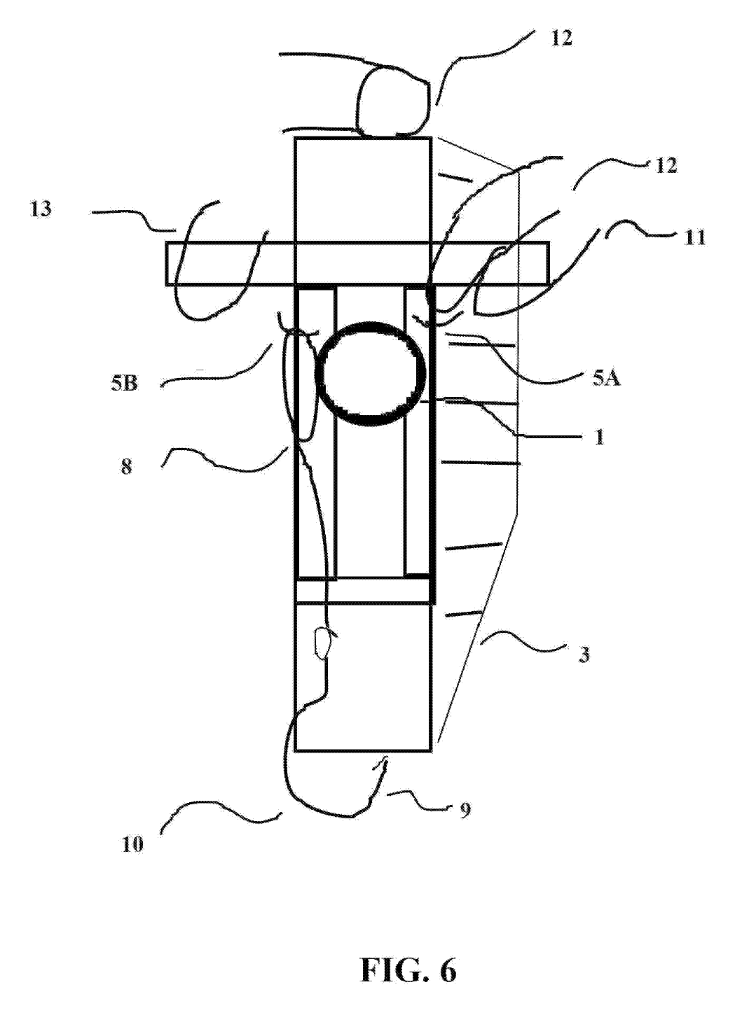

5. The T shaped part (FIG. 3) has one or more hook projections (FIG. 3, 5A and 5B) so that one of the hook like projection (FIG. 6, 5B) can go through the loop (FIG. 5, 8 and FIG. 6,8) in the leader fishing line (FIG. 6, 5B).

6. The Hook like projections are installed in the T shaped part (FIG. 3, 5A-5B) at a location which makes the leader (FIG. 5,8 and FIG. 6,8) taught and the hook press against the chisel part of the rod, when the rod is pressed down using the pressure from the thumb.

7. The T shaped part is pressed in the opposite (FIG. 6, 12-13-14) directions resulting from the pressure applied by the thumb and fingers, causing the leader to became taught, and causing the hook to be pressed against the chisel part of the rod (FIG. 6,3).

8. The hooks (FIG. 3, 5A-5B) can consist of flat headed steel screws screwed into the T (FIG. 3) making between a 45 to 20 degree angle with the side of the T shaped part leading to the top of the T shaped part.
